(19) United States
(12) Patent Application Publication
(10) Pub. No.: US 2025/0343333 A1
(43) Pub. Date: Nov. 6, 2025

(54) BATTERY PACK

(71) Applicant: MILWAUKEE ELECTRIC TOOL CORPORATION, Brookfield, WI (US)

(72) Inventors: Andrew J. Spaulding, Racine, WI (US); Kyle C. Fassbender, Brookfield, WI (US); Matthew R. Polakowski, Greenfield, WI (US)

(21) Appl. No.: 19/194,692

(22) Filed: Apr. 30, 2025

Related U.S. Application Data
(60) Provisional application No. 63/641,337, filed on May 1, 2024.
(60) Provisional application No. 63/725,390, filed on Nov. 26, 2024.

(51) Int. Cl. H01M 50/516; H01M 10/42; H01M 10/48; H01M 50/233; H01M 50/247; H01M 50/284

(52) U.S. Cl. CPC H01M 50/516; H01M 10/4257; H01M 10/486; H01M 50/233; H01M 50/247; H01M 50/284; H01M 2010/4271

(57) ABSTRACT

A battery pack including a housing and a cell frame supported within the housing. The cell frame includes a plurality of openings to secure a plurality of battery cells, and a weld strap disposed within the cell frame configured to interconnect the plurality of battery cells. The battery pack also includes a cell header cover disposed adjacent to the battery cells and covering the weld strap. The cell header cover is configured to prevent battery cell particulate from circulating within the outer housing. The cell header cover and the cell frame cooperate to surround the battery cells.

### CROSS-REFERENCE TO RELATED APPLICATIONS

The present application claims priority to U.S. Provisional Application No. 63/641,337, filed May 1, 2024, and U.S. Provisional Application No. 63/725,390, filed Nov. 26, 2024, the entire contents of each of which are incorporated by reference herein.

### FIELD

The present disclosure relates to battery packs including battery packs for power tools.

### SUMMARY

Thermal runaway is caused by a decomposition reaction of the electrolytes within a battery cell reacting uncontrollably. The decomposition reactions are both exothermic and increase in rate as the temperature increases. Furthermore, as a battery cell heats up and reaches a critical temperature, portions of the battery cell break down driving additional reactions and uncontrolled heat generation. As a result, the reaction is exponentially self-heating and often results in the rupture of the battery cell where hot gasses and electrolyte are released into the environment. Broadly, thermal runaway can be induced mechanically, electrically, and/or thermally. For example, puncturing a battery cell may result in mixing of the electrolytes and a short circuit within the battery. A battery short circuit can rapidly heat due to Joule heating, causing a battery cell to reach a critical temperature wherein thermal runaway ensues. Similarly, simply heating a battery to the critical temperature will result in the decomposition of the battery's components and eventually may lead to thermal runaway. In constructions where a plurality of battery cells is in close proximity to one another, such as a battery pack, thermal runaway in one battery cell may propagate to nearby cells. The present disclosure is directed to the prevention of a thermal runaway event from cascading into other cells.

The disclosure provides, in one independent aspect, a battery pack including a housing and a cell frame supported within the housing. The cell frame includes a plurality of openings to secure a plurality of battery cells, and a weld strap disposed within the cell frame configured to interconnect the plurality of battery cells. The battery pack also includes a cell header cover disposed adjacent to the battery cells and covering the weld strap. The cell header cover is configured to prevent battery cell particulate from circulating within the outer housing 104. The cell header cover and the cell frame cooperate to surround the battery cells.

The disclosure provides, in another independent aspect, a battery pack including: a housing; a plurality of battery cells supported within the housing; an interface disposed on the housing and electrically connected to the plurality of battery cells, the interface configured to couple with a power tool; a weld strap disposed within the cell frame, the weld strap configured to interconnect the plurality of battery cells and the printed circuit board; a first fused connection between the weld strap and an at least one battery cell of the plurality of battery cells, wherein the fused connection is configured to disconnect the weld strap and the at least one battery cell upon reaching a temperature threshold.

The disclosure provides, in another independent aspect a housing including a first housing portion and a second housing portion, the first housing portion secured to the second housing portion and defining a cavity therebetween, and the first housing portion defining an interface configured to couple to a power tool; a cell frame supported within the cavity, the frame including a plurality of openings to secure a battery cell; a gas sensor disposed within the cavity, the gas sensor configured to detect the presence of gasses produced during decomposition of the battery cell; an electronic controller configured to disable power transfer upon determining the battery cell has vented gas using the gas sensor.

Other aspects of the embodiments will become apparent by consideration of the detailed description and accompanying drawings.

### BRIEF DESCRIPTION OF THE DRAWINGS

FIG. 1 is a perspective view of a battery pack according to a first construction.

FIG. 2 is a side cross-sectional view taken from line 2-2 in FIG. 1.

FIG. 3 is a side view of a cell frame of a battery pack of FIG. 1.

FIG. 4 is a side view of the cell frame of FIG. 3 including a weld strap cover.

FIG. 5A is an exemplary circuit diagram of the battery cells within the battery pack.

FIG. 5B is a diagram of a modified contact of a weld strap.

FIG. 6 is an exemplary diagram of battery cells surrounded by a gap filler.

FIG. 7 is an exemplary schematic of a battery pack enclosure.

FIG. 8 is a perspective view of a battery pack according to a second construction.

FIG. 9 is a control diagram for the battery packs of FIGS. 1-6.

FIG. 10 is flow chart illustrating a method for determining whether a battery cell is venting gas.

### DETAILED DESCRIPTION

Before any independent constructions of the disclosure are explained in detail, it is to be understood that the disclosure is not limited in its application to the details of construction and the arrangement of components set forth in the following description or illustrated in the following drawings. The disclosure is capable of other independent constructions and of being practiced or of being carried out in various ways.

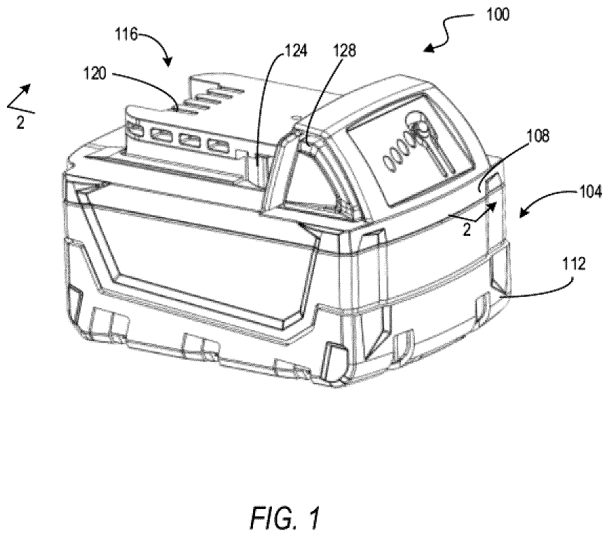

FIGS. 1-4 illustrate a battery pack according to a first construction. The battery pack 100 includes an outer housing 104 including a first portion 108 and a second portion 112. The first portion 108 of the battery pack 100 includes a tool interface 116 that is mechanically and electrically couplable to a power tool or another electric device. The tool interface 116 includes a plurality of terminals 120 and a latch 124. The latch 124 is coupled to a corresponding button 128 to operatively couple the tool interface 116 to a corresponding electric device, such as a power tool. The second portion 112 includes a cover coupled to the first portion 108 of the battery pack using a fastener (not shown). The first portion 108 and the second portion 112 sealingly define a cavity 132 therebetween.

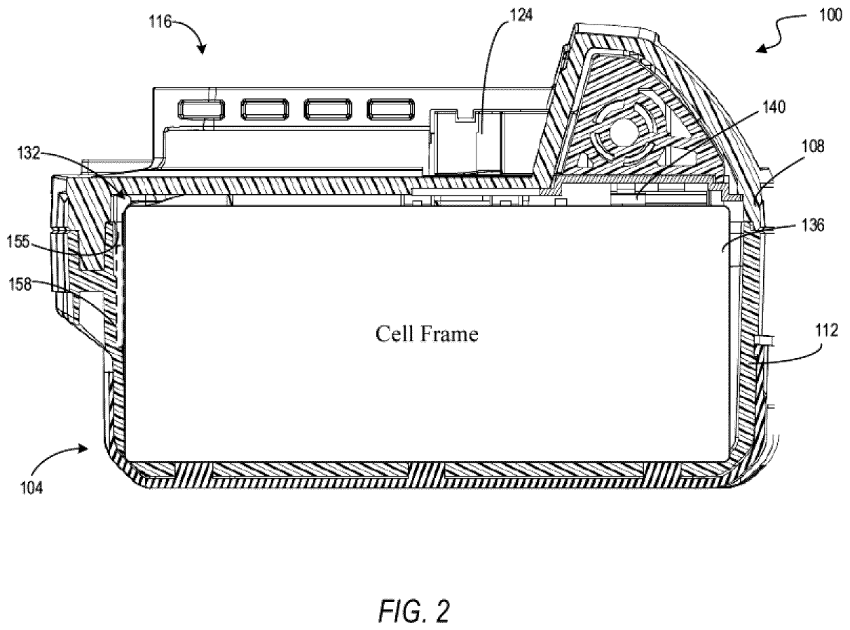

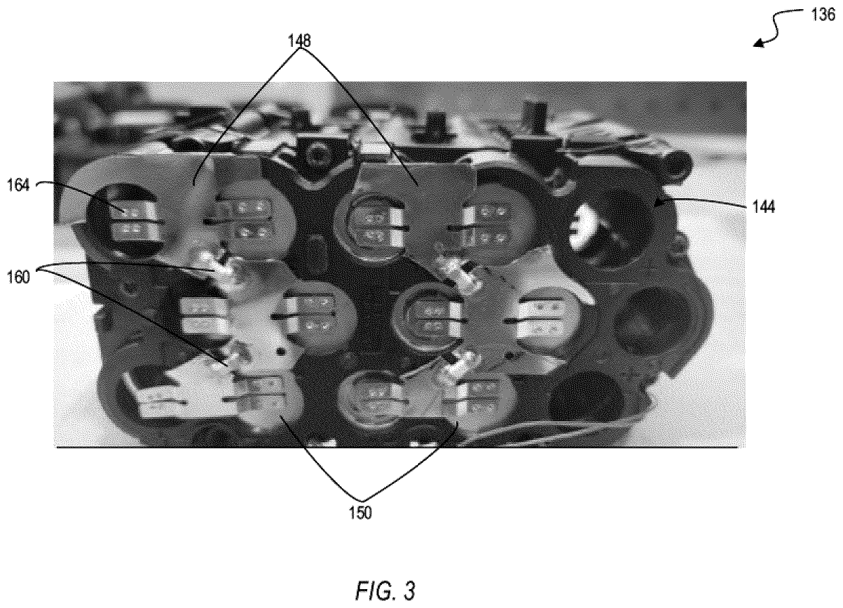

With reference to FIGS. 2-3, the battery pack 100 further includes a cell frame 136 and a PCB 140 supported within the cavity 132 of the outer housing 104. The cell frame 136 includes a plurality of openings 144 (see FIG. 3) and a plurality of weld straps 148. The openings 144 are sized and spaced to house corresponding battery cells 150. Said another way, the battery cells 150 are secured within the openings 144. In the illustrated construction, the battery cells 150 are cylindrical in shape and define a cell can and opposite cell headers. In other constructions other types of batteries (e.g., pouch cell) may be implemented. The weld straps 148 interconnect the battery cells 150 to one another and couple the battery cells 150 to the PCB 140. The weld straps 148 may connect the battery cells 150 in series, parallel, or a combination thereof. The PCB 140 is coupled to the cell frame 136 and controls the power transferred between the battery cells 150 and the terminals 120 of the tool interface 116.

As shown in FIG. 3, the openings 144 may surround each individual cell, thereby supporting and protecting the battery cells 150. During thermal runaway, battery cells 150 may rupture, resulting in the release of cell ejecta (e.g., parts of the cell can and vaporized electrolyte) and/or flame. It will be appreciated that surrounding the battery cells 150 with a solid cell frame 136 reduces the air space between the battery cells 150 and thereby prevents the cell ejecta from one malfunctioning cell from reaching the surrounding cells and thereby propagating thermal runaway. For example, shrapnel from a malfunctioning cell can may impact the cell frame 136 and subsequently be directed away from the adjacent cells. In some constructions, the cell frame 136 may at least partially include thermally conductive material to dissipate heat from a battery cell approaching thermal runaway. It will be appreciated that thermally conductive material will more evenly distribute the temperature of the battery cells, preventing or increasing the amount of time required for a hot spot to reach the critical temperature and thereby undergo thermal runaway. In some constructions the cell frame 136 may be formed as a single solid piece. In other constructions portions of the cell frame 136 may be coupled together using fasteners or other methods known in the art such as adhesive.

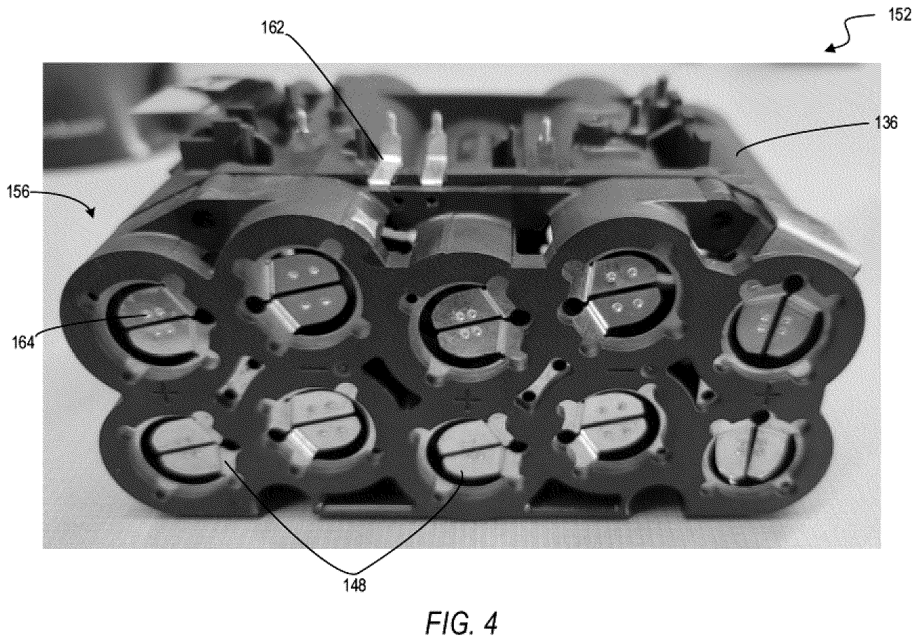

As shown in FIG. 4, in some constructions the weld straps 148 are integrated into the cell frame 136 to form an integrated cell frame 152. As previously discussed, the weld straps 148 couple the battery cells 150 together. Accordingly, during a thermal runaway event, damage to one weld strap of one battery cell may propagate to the other battery cells through the weld strap. For example, cell ejecta from one malfunctioning cell may eject the connected weld strap away from the cell frame 136. The weld strap may then pull the other connected battery cells and/or the PCB 140 out of place causing the battery circuit to be shorted or otherwise damaged. It will accordingly be appreciated that reinforcing the weld straps 148 trap the weld straps 148 in a fixed location and limit the damage resulting from thermal runaway. Specifically, the integrated cell frame 152 may reduce the amount of energy transferred into the weld straps 148 during the ejection of particulate. The integrated cell frame 152 also limits the accessible surface area of vulnerable electrical components and accordingly protects the weld straps 148 and the PCB 140 from particulate. Integrating the weld straps 148 into the cell frame 136 also reduces the number of steps required in assembling and manufacturing the battery pack 100. In some constructions, the integrated cell frame 152 may be formed a unitary piece. In the illustrated construction, the integrated cell frame 152 may include a separate cell frame 136 coupled to a reinforced weld strap cover 156 via fasteners or other coupling means known in the art. In other constructions, the weld straps 148 may be laser welded or resistance welded into the cell frame 136. In some constructions the PCB 140 may also be supported within the cell frame.

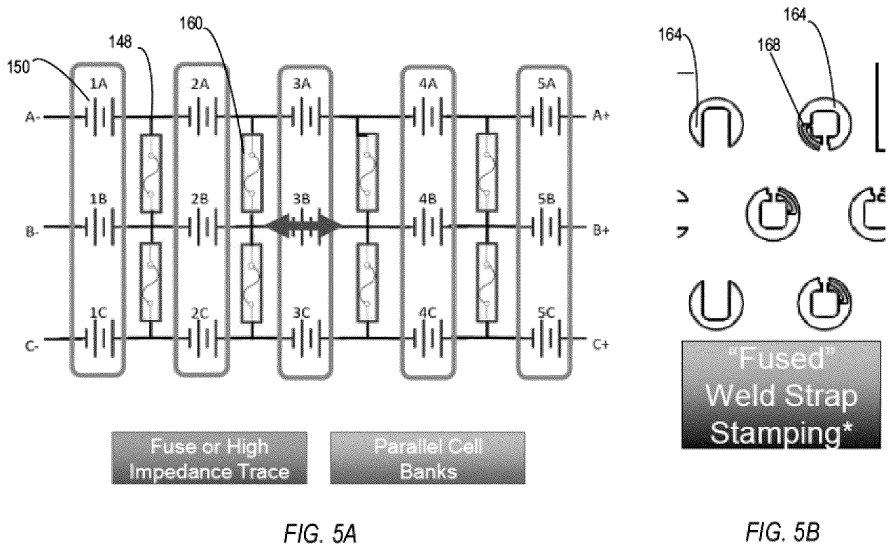

As shown in FIGS. 5A and 5B, the battery pack 100 may include a “fused” connection between parallel cells and/or between each of the weld straps 148 and the battery cells 150. When a battery cell malfunctions and/or goes into thermal runaway, the malfunctioning cell becomes a direct short to the other parallel cells within the battery and produces current flow in the battery cells in series with the malfunctioning cell. This is a mechanism that will cause the other cells to also malfunction and/or go into thermal runaway. Similar to a standard electrical fuse, a “fused” connection is an electrical connection that will open in the event of a shorted (e.g., malfunctioning) cell. A “fused” connection prevents the propagation of thermal runaway by disconnecting the “fused” connection from the electrical circuit upon reaching a specific current or temperature. In some constructions, the “fused” connection may create an open circuit based on the surrounding temperature. In other constructions, the “fused” connection may create an open circuit based on the current. It will be appreciated that a “fused” connection configured to create an open circuit upon reaching a specific temperature will also be responsive to the Joule heating resulting from current flow. The “fused” connection may be an electrical component, a chemical bonding, or a physical coupling. The additional protection provided by the “fused” connection may also protect the battery pack 100 in the event of a short circuit, overcharging, and/or an ingress of liquid.

In the construction illustrated in FIG. 3 and as exemplified in the circuit diagram of FIG. 5A, one example of a “fused” connection includes a SMD fuse 160 disposed on the weld straps 148 connecting the battery cells 150 in parallel or on cell tabs 162 disposed on the PCB 140. Said another way, a first weld strap and a second weld strap may connect to the plurality of battery cells 150 to form a parallel circuit with a fuse 160 disposed in between. The fuse 160 may disconnect the first weld strap from the second weld strap upon reaching a threshold current. The fuse 160 may be mounted on the surface of the weld straps or integrated with one or more of the weld straps as one piece. In other constructions, the “fused” connection may include a specifically calibrated bonding between the wires, ribbons, weld straps 148, battery cells 150 and/or the busbars (for example bonding aluminum or copper). For example, the “fused” connection may be a low-temperature solder configured to disconnect the electrical connection upon reaching a certain temperature associated with a short. With specific attention to FIG. 5B, the “fused” connection may include a modified geometry in the weld strap stamping 164 to purposefully create sections that will be more sensitive to changes in current. The weld strap stamping 164 geometries may also be modified to provide a path for melted solder to flow without risking an additional short. For example, in the construction illustrated in FIG. 5B, the weld strap stamping 164 includes a channel 168. It will be appreciated that the different constructions of “fused” connections discussed do not preclude one another and accordingly may be used in combination. The “fused” connection may include a smart weld between different components. For example, the cell tabs 162 may be made of aluminum and the weld straps 148 may be made of copper. The cell tabs 162 and the weld straps 148 may be resistance welded together in such a way that the cell tabs 162 disconnect from the weld straps 148 upon reaching a particular temperature.

Returning reference to FIGS. 2-3, in some constructions, the battery pack 100 may include a protective coating 158 on an inner surface 155 of the outer housing 104, the PCB 140, the cell headers, and/or the cell cans. The protective coating 158 may be fire resistant and may accordingly prevent the spread of fire from a malfunctioning cell to an adjacent component. For example, the cell headers and cell can may be less likely to short, melt, and/or go into thermal runaway when coated with a fire-resistant coating. In some constructions, a protective coating 158 may additionally coat other portions of the battery pack 100 such as the outer surface of the outer housing 104 to prevent an external fire from melting the outer housing. The protective coating 158 may additionally or alternatively act as a barrier to reduce the kinetic energy of any particulate vented from the battery cells 150. For example, a protective coating 158 on the inside of the outer housing 104 may prevent cell ejecta from penetrating and exiting the outer housing 104. In another example the protective coating 158 may include a silicone foam pad disposed over the cell frame 136 to absorb the vented particulate and prevent the hot particulate from circulating within the outer housing 104 and causing adjacent cells to undergo thermal runaway. In some constructions, the protective coating 158 and the cell frame 136 may cooperate to surround the battery cells 150. The protective coating 158 may also absorb impacts or vibration to the outer housing 104 and provide a layer of protection from ingress. Some examples of protective coatings may include HB Fuller EVProtect 1000, BISCO Silicones, and BISCO FPC Silicone Fire Barrier.

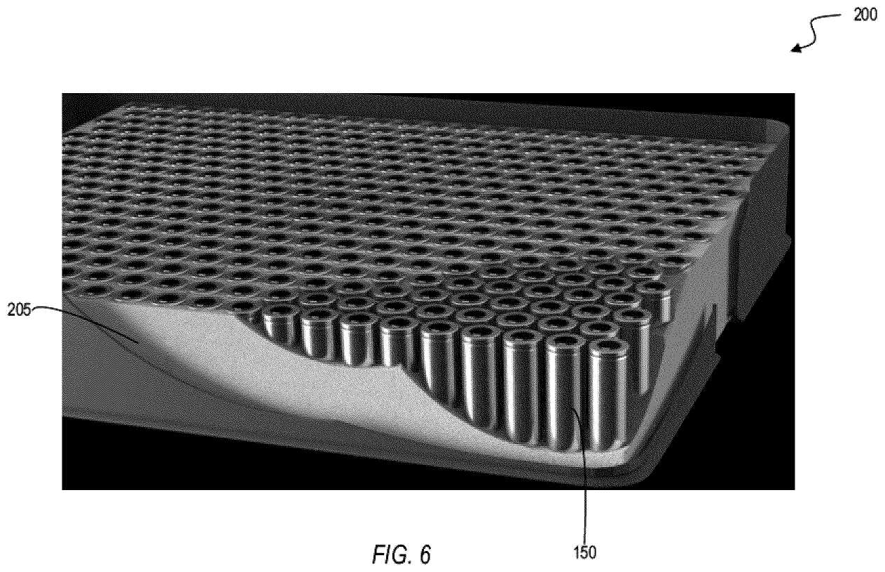

As shown in the exemplary diagram 200 of FIG. 6, in some constructions, the battery cells 150 may additionally or alternatively be wrapped, coated, and/or encased in a gap filler 205. For example, the gap filler 205 may be applied between the battery cells 150 and openings 144. As previously discussed, decreasing the open-air volume within the battery pack the reduces the spread of cell ejecta and accordingly reduces the probability of a fire starting and spreading from a malfunctioning cell. The gap filler 205 minimizes the open-air volume surrounding the battery cells 150 and accordingly isolate a malfunctioning cell from adjacent cells. The gap filler 205 may also surround the headers of the battery cells 150 and accordingly fully encapsulate the battery cells 150. The gap filler 205 also absorbs a portion of the kinetic energy and heat of any vented particulate from the malfunctioning cell. Examples of a gap filler material include Weldtone WT3011FR and HB Fuller EV protect 4006/5006.

In some constructions, the battery cells 150 and/or the cell frame 136, 152 may be wrapped in a fire-retardant wrap to fill the open-air volume within the battery pack and to reinforce the cell frame 136, 152 thereby further reducing the probability of a fire starting and spreading. In some constructions the wrap may be a flexible material (e.g., cloth, nylon, etc.) and may provide additional structural rigidity and impact resistance to the cell frame 136, 152. Additionally, in constructions where the wrap may fully encase each battery cell 150, the wrap may act as barrier between released cell ejecta and open air spaces, thereby containing the spread of thermal runaway.

The inclusion of a protective coating 158, wrap, or gap filler 205 may also reduce the likelihood of a battery fire during a short circuit or overcharge failure. It will be appreciated that the inclusion of the gap filler 205 does not preclude a protective coating 158 or wrap and accordingly the gap filler 205 may be applied over a protective coating 158, or the protective coating 158 may be disposed over the gap filler 205. In other constructions some portions of the battery cells 150, such as the cell cans, may be encapsulated by the gap filler 205 and other portions, such as the headers, may be coated with a protective coating 158. Similarly, in some constructions the entire cell frame 136, 152 may be wrapped in a flame-resistant wrapping on top of the protective coating 158 and gap filler 205.

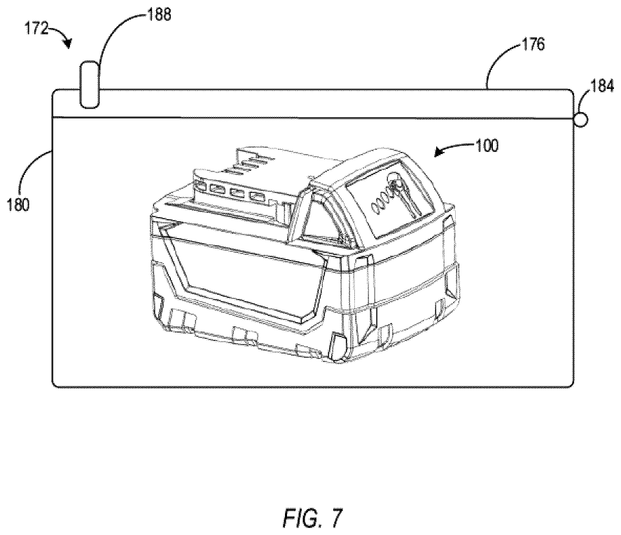

It will be appreciated that the principles of limiting thermal runaway disclosed are not limited to the contents of a battery pack 100. As illustrated in FIG. 7, an enclosure 172 may further isolate the battery cells 150 from the external environment by sealing the battery pack 100 within. In addition to providing additional protection from external sources of damage or ingress, the enclosure 172 may limit or substantially eliminate the supply of oxygen surrounding the battery cells 150. It will be appreciated that limiting the supply of oxygen may correspondingly limit the formation and spread of fire. In the event of a thermal runaway event that breaks beyond the battery pack 100, the enclosure may also contain the ejecta from the battery pack 100 including portions of the outer housing 104 of the battery pack 100. Accordingly, the enclosure 172 may be formed of a flame-resistant material and be strong enough to fully capture cell ejecta from the battery pack 100. The enclosure 172 may be configurable between a sealed configuration where the battery cells 150 are isolated from the ambient environment surrounding the enclosure 172 and an unsealed configuration where the battery cells 150 are accessible and in contact with the ambient environment. The enclosure 172 may additionally include battery pack terminals to allow for the charging or discharging of the battery packs 100. For example, in some constructions the enclosure 172 may be disposed on or integrated with an external device (e.g., a handheld power tool, a lawnmower, a charger, etc.). In other constructions, the enclosure 172 may include temperature and gas sensors to monitor the condition of the battery disposed within the enclosure.

To reduce the volume of air surrounding the battery pack 100 within the enclosure 172, the enclosure 172 may have similar dimensions to the battery pack 100. For example, the enclosure 172 may provide a small (e.g., ranging between 0.5 to 1.5 inches, ranging between 0.25 and 1 inches, ranging between 0.75 and 1.25 inches, etc.) distance between the enclosure 172 and each side of the battery pack 100. In other constructions the distance between the enclosure 172 and each side of the battery pack 100 may not be uniform. For example, in constructions where the enclosure 172 is integrated with an external device, the tool interface 116 of the battery pack 100 may be configured to mate with a corresponding battery pack interface of the external device.

In the construction illustrated in FIG. 7, the enclosure 172 is a rigid housing. In such a construction, the enclosure 172 includes a lid 176 sealingly coupled to an enclosure base 180 by a hinge 184. The lid 176 is pivotable relative to the base 180 about the hinge 184 between the unsealed configuration and the sealed configuration. The enclosure 172 may also include a latch or another means for securing a seal between the enclosure base 180 and lid 176. The lid 176 may also include a pressure release 188 such as a gasket to allow for pressure within the enclosure to be released. In some constructions the enclosure 172 may include or work in conjunction with a heat sink to allow for heat to transfer from the battery pack 100 outside of the enclosure 172. The enclosure 172 may also include additional active or passive cooling such as a heat exchange loop to maintain the temperature within the enclosure within a predetermined temperature range.

In other configurations the enclosure 172 may be flexible and be formed as a blanket, cover, or pouch. The flexible enclosure may be flexible and soft enough to provide a snug fitting to fully cover the battery pack 100. Additionally, the snug fitting may be sealable and/or flame resistant to smother any fires resulting from a thermal runaway event of the battery pack. For example, a soft blanket may be foldable to fully cover a battery pack 100 with one or more layers of flame-retardant material to limit the spread of fire and the supply of oxygen provided to the battery pack 100 from the ambient environment. Similarly, a pouch may be fully sealable and filled with a non-reactive gas (e.g., nitrogen, argon, etc.) to largely eliminate the supply of oxygen.

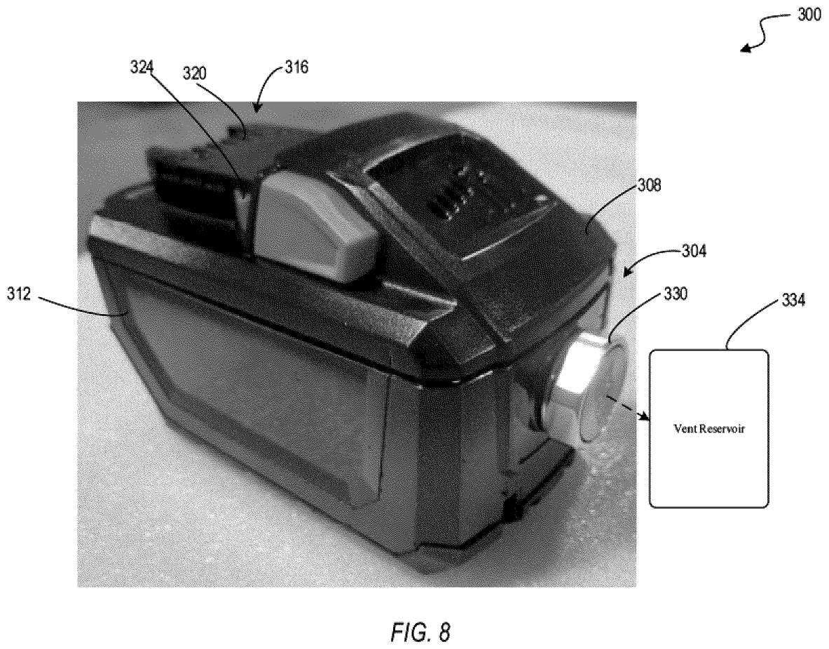

FIG. 8 illustrates a battery pack 300 according to a third construction. The battery pack 300 is similar in some aspects to the battery pack 100, with like parts having like reference numerals plus “200.” Similar to the battery pack 100, the battery pack 300 includes an outer housing 304 with a first portion 308 and a second portion 312. The first portion 308 includes an interface 316 including terminals 320 and a latch 324 for coupling the battery pack 300 to an electronic device such as a power tool. The battery pack 300 also includes a pressure release 330 or vent valve. In the event of cell thermal runaway, a large amount of energy and volume of particulate is vented into the battery pack 300. Accordingly, without adequate venting, the outer housing 304 may be compromised. Accordingly, venting the battery pack 300 helps mitigate the propagation of cell failures and thermal failure by releasing the battery pack pressure. A pressure release 330 may guide vented gases in a specific direction away from the battery pack or user. For example, in some constructions, the pressure release 330 directs excess gas into an external housing such as vent reservoir 334. The pressure release 330 also prevents ingress into the battery pack 300. The illustrated pressure release 330 of FIG. 8 is a Gore vent valve. However, in other constructions, other pressure releases may be used.

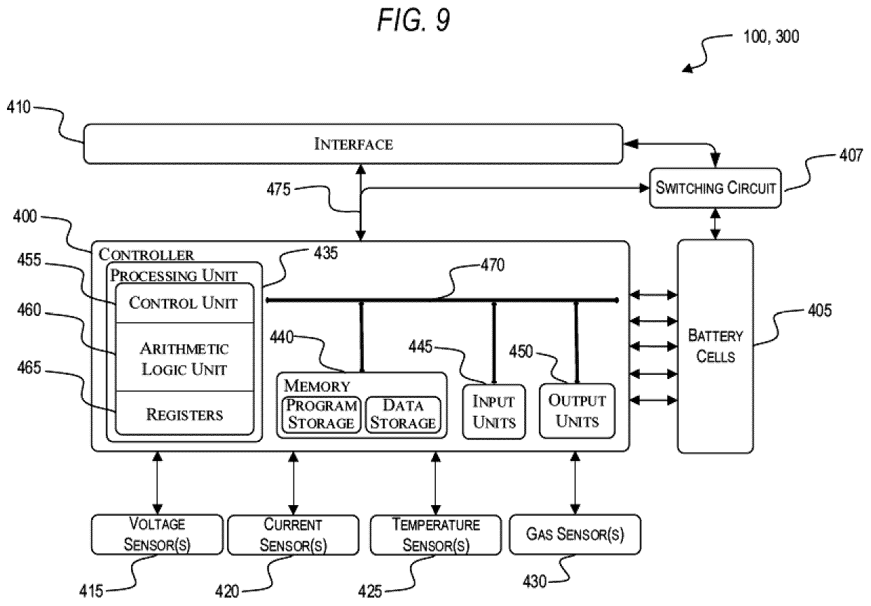

FIG. 9 illustrates a block diagram of the control system for the battery packs 100, 300. The control system includes a controller 400 that is electrically and/or communicatively connected to a variety of modules or components of the battery packs 100, 300. For example, the illustrated controller 400 is connected to one or more battery cells 405 (e.g., battery cells 150) and an interface 410. The control system may also include a switching circuit 407 operable to disconnect the battery cells 405 from the interface 410. The controller 400 is also connected to one or more sensors including one or more voltage sensors 415 or voltage sensing circuits, one or more current sensors 420 or current sensing circuits, one or more temperature sensors 425 or temperature sensing circuits and one or more gas sensors 430 or gas sensing units. In some constructions, the control system and associated sensors may be integrated into a printed circuit board (e.g., PCB 140).

The controller 400 includes combinations of hardware and software that are operable to, among other things, control the operation of the battery packs 100, 300, monitor a condition of the battery packs 100, 300, enable or disable charging of the battery packs 100, 300, and enable or disable discharging of the battery packs 100, 300, etc.

The controller 400 includes a plurality of electrical and electronic components that provide power, operational control, and protection to the components and modules within the controller 400 and/or the battery packs 100, 300. For example, the controller 400 includes, among other things, a processing unit 435 (e.g., a microprocessor, a microcontroller, an electronic processor, an electronic controller, or another suitable programmable device), a memory 440, input units 445, and output units 450. The processing unit 435 includes, among other things, a control unit 455, an arithmetic logic unit (“ALU”) 460, and a plurality of registers 465 and is implemented using a known computer architecture (e.g., a modified Harvard architecture, a von Neumann architecture, etc.). The processing unit 435, the memory 440, the input units 445, and the output units 450, as well as the various modules or circuits connected to the controller 400 are connected by one or more control and/or data buses (e.g., common bus 470). The control and/or data buses are shown generally in FIG. 9 for illustrative purposes. The use of one or more control and/or data buses for the interconnection between and communication among the various modules, circuits, and components would be known to a person skilled in the art in view of the embodiments described herein.

The memory 440 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 435 is connected to the memory 440 and executes software instructions that are capable of being stored in a RAM of the memory 440 (e.g., during execution), a ROM of the memory 440 (e.g., on a generally permanent basis), or another non-transitory computer readable medium such as another memory or a disc. The software includes, for example, firmware, one or more applications, program data, filters, rules, one or more program modules, and other executable instructions. The controller 400 is configured to retrieve from the memory 440 and execute, among other things, instructions related to the control processes and methods described herein. In other constructions, the controller 400 includes additional, fewer, or different components.

The interface 410 (e.g., tool interface 116) includes a combination of mechanical components (e.g., rails, grooves, latch 124, etc.) and electrical components (e.g., terminals 120) configured to and operable for interfacing (e.g., mechanically, electrically, and communicatively connecting) the battery cells 405 of a battery packs 100, 300 with an external device. For example, the interface 410 is configured to receive power through a charging circuit via a power input circuit. The interface 410 is also configured to communicatively connect to the controller 400 via a communications line 475. Accordingly, the controller 400 may control the charging of the battery packs 100, 300 through the interface 410. Additionally, the interface 410 is also configured to output power through a discharge circuit. As such, the controller 400 may also control the output of the battery packs 100, 300 through the interface 410.

The one or more gas sensors 430 detect the presence of gasses produced during decomposition of a battery cell. For additional context, several reactions occur in a battery cell below the critical temperature where thermal runaway begins. Specifically for lithium-ion cells, beginning at temperatures as low as around ninety degrees Celsius, the solid electrolyte interface (SEI) breaks down leading to uncontrolled reactions between the electrolyte, cathode, and anode. The gasses vented by these reactions within the battery cell include hydrogen, carbon dioxide, ethane, hydrogen fluoride, and carbon monoxide. The gas sensor 430 may be calibrated to detect the presence of a specific gas or the presence of a combination of multiple gasses. For example, hydrogen and ethane are rarely naturally found in the atmosphere and thus when detected by the gas sensor 430 may indicate that a battery cell is venting gas. The gas sensor 430 may be calibrated to send a fault signal upon detecting a specific concentration of a gas. For example, in large enough concentrations both carbon dioxide and carbon monoxide are dangerous and are likely indicators that a battery cell is venting. The gas sensor 430 may include a semiconductor gas sensor, an electrochemical gas sensor, an infrared gas sensor, or another gas sensor known in the art. In some constructions, the gas sensor 430 may be disposed on the PCB 140 and may be used to detect the gasses within the cavity 132.

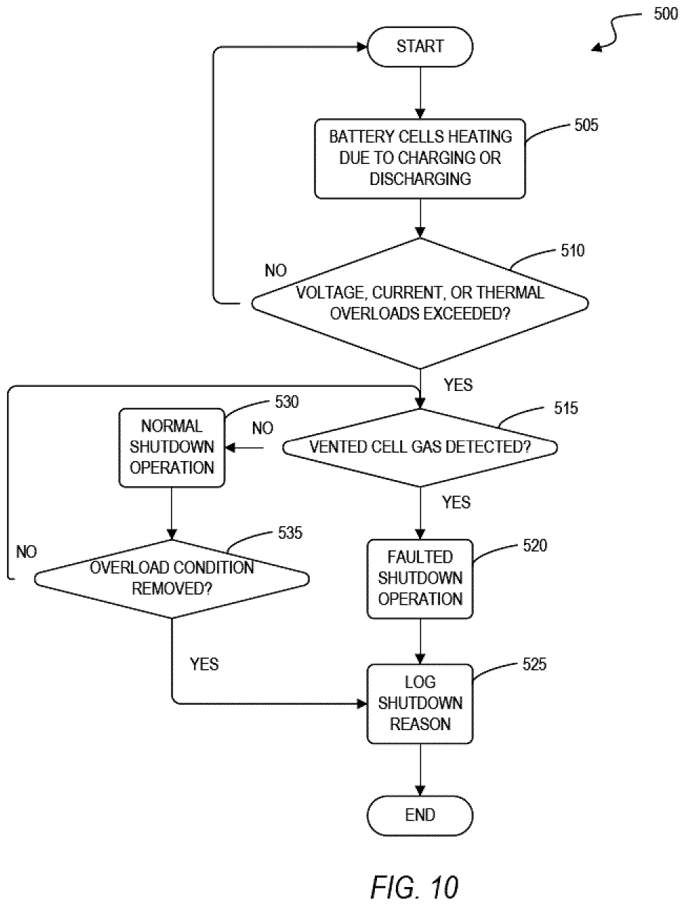

FIG. 10 illustrates an exemplary method 500 of detecting the presence of gasses produced during decomposition of at least one of the battery cells. At step 505, battery cells are heated due to charging or discharging. The battery cells may also be heated due to external means such as a heater. At step 510, the controller 400 determines if the voltage, current, or thermal overloads are exceeded. The controller 400 may respectively communicate with the voltage sensors 415, current sensors 420, and temperature sensors 425 to determine whether each of the voltage, current, or thermal overloads are exceeded. The controller 400 may compare signals from the sensors 415, 420, 425 with a preprogrammed threshold stored in memory 440 to determine if an overload is exceeded. At step 515, upon determining that one of the voltage, current, or thermal overloads are exceeded, the controller 400 determines if vented cell gas is detected. The controller 400 determines whether vented cell gas is detected based on the signal from the gas sensor 430. It will be appreciated that the temperature at which gasses and vapors are produced at the beginning of decomposition are lower than the critical temperature where a battery cell undergoes thermal runaway. Therefore, thermal runaway can be predicted and potentially prevented. At step 520, upon detecting vented cell gas, the controller 400 begins a faulted shutdown operation. The faulted shutdown operation may disable all normal functionality including charging and discharging of the battery pack 100, 300 to prevent additional cell heating. The faulted shutdown operation may attempt to identify and remove the malfunctioning cell from the battery circuit. For example, the controller may communicate with the voltage sensor 420 to determine that a battery cell is not operating at the expected voltage. After identifying the malfunctioning cell, the controller may disconnect the malfunctioning cell from the battery circuit using the switching circuit 407. In some constructions the switching circuit 407 may create an open circuit around the malfunctioning cell. In other constructions, the switching circuit 407 may disconnect all cells in series with the malfunctioning cell from the battery circuit. The faulted shutdown operation may permanently disable battery functionality to ensure that the battery pack 100, 300 is serviced. After the faulted shutdown has completed, the reason for the shutdown as best identified by the controller 400 is logged at step 525. Returning now to step 515, if the answer to whether vented cell gas is detected is “no,” a normal shutdown operation is performed at step 530. Because no vented cell gas has been detected, any malfunction or other condition causing the overload condition could be something other than a malfunctioning cell. For instance, the environment in which the battery is present may be too hot for normal battery operation. Upon normal shutdown, the controller 400 determines whether the overload condition has been removed at step 535. This step may be the same determination as in step 510, or another determination based on different parameters may be made. If the overload condition is determined to have not yet been removed, the controller 400 once more inquires as to whether vented cell gas is detected at step 515. This loop of inquiry while an overload condition remains present may be performed a limited number of times or may be performed periodically after a threshold amount of time has passed. If the overload condition is determined to have been removed, the reason for the shutdown as best identified by the controller 400 is logged at step 525.

Although the disclosure has been described with reference to certain preferred aspects, variations and modifications exist within the scope and spirit of one or more independent aspects of the disclosure as described. Various features and advantages of the disclosure are set forth in the following claims.

What is claimed is:

1. A battery pack comprising:
a housing including a first housing portion and a second housing portion, the first housing portion secured to the second housing portion and defining a cavity therebetween, and the first housing portion defining an interface configured to couple to a power tool;
a cell frame supported within cavity of the housing, the cell frame including
a plurality of openings to secure a plurality of battery cells, and
a weld strap disposed within the cell frame, the weld strap configured to interconnect the plurality of battery cells; and
a cell header cover disposed adjacent to the plurality of battery cells and covering the weld strap, the cell header cover configured to prevent battery cell particulate from circulating within the housing;
wherein the cell header cover and the cell frame cooperate to surround the plurality of battery cells.

2. The battery pack of claim 1, wherein the housing further includes an inner surface and an outer surface, and wherein the inner surface includes a protective layer configured to prevent cell ejecta from penetrating and exiting the housing.

3. The battery pack of claim 1, wherein the cell header cover is a silicone foam padding.

4. The battery pack of claim 1, wherein the weld strap is integrated into the cell frame as a single piece.

5. The battery pack of claim 1, further comprising a fused connection between the weld strap and the plurality of battery cells.

6. The battery pack of claim 1, wherein the cell frame is thermally conductive and is configured to dissipate heat from the plurality of battery cells.

7. The battery pack of claim 1, wherein each of the plurality of battery cells is coated with a fire-resistant coating.

8. The battery pack of claim 1, wherein the plurality of battery cells is encapsulated by a gap filler, and wherein the gap filler surrounds at least a portion of the cell frame.

9. The battery pack of claim 1, further comprising a vent valve configured to vent particulate out of the cavity.

10. The battery pack of claim 9, further comprising a vent reservoir coupled to the housing, the vent reservoir configured to receive the particulate vented from the vent valve.

11. A battery pack comprising:
a housing;
a plurality of battery cells supported within the housing;
an interface disposed on the housing and electrically connected to the plurality of battery cells, the interface configured to couple with a power tool;
a first weld strap disposed within the housing, the first weld strap configured to interconnect the plurality of battery cells; and
a first fused connection between the first weld strap and at least one battery cell of the plurality of battery cells, wherein the first fused connection is configured to disconnect the first weld strap and the at least one battery cell upon reaching a temperature threshold.

12. The battery pack of claim 11, wherein fused connection is a low-temperature solder configured to melt upon reaching a temperature threshold.

13. The battery pack of claim 12, wherein the first weld strap includes channel for solder to flow without risking an additional short.

14. The battery pack of claim 11, further comprising a printed circuit board disposed within the housing and coupled to the interface and the first weld strap, wherein a second fused connection is a smart weld between the first weld strap and the printed circuit board configured to disconnect the first weld strap and the printed circuit board upon reaching a temperature threshold.

15. The battery pack of claim 11, further comprising a second weld strap disposed within the housing and configured to interconnect the plurality of battery cells, wherein the first weld strap and the second weld strap form a parallel circuit.

16. The battery pack of claim 15 further comprising a fuse between the first weld strap and the second weld strap, the fuse configured disconnect the first weld strap from the second weld strap upon reaching threshold current.

17. A battery pack comprising:
a housing including a first housing portion and a second housing portion, the first housing portion secured to the second housing portion and defining a cavity therebetween, and the first housing portion defining an interface configured to couple to a power tool;
a cell frame supported within the cavity, the cell frame including a plurality of openings to secure a battery cell;
a gas sensor disposed within the cavity, the gas sensor configured to detect a gas produced by the battery cell; and
an electronic controller configured to disable power transfer upon determining, using the gas sensor, the battery cell has produced the gas.

18. The battery pack of claim 17, wherein the electronic controller determines the battery cell has produced the gas by detecting, using the gas sensor, the presence of hydrogen within the cavity.

19. The battery pack of claim 17, wherein the electronic controller determines the battery cell has produced the gas by determining, using the gas sensor, that a concentration of carbon dioxide within the cavity is greater than a predetermined threshold.

20. The battery pack of claim 17 further comprising a voltage sensor configured to determine a voltage of the plurality of battery cells, and a temperature sensor configured to determine a temperature of the plurality of battery cells, wherein the voltage sensor and the temperature sensor are each configured to detect a malfunctioning battery cell.
